(19) United States
(12) Patent Application Publication
(10) Pub. No.: US 2024/0082810 A1
(43) Pub. Date: Mar. 14, 2024

(54) LOW-COST NOVEL ADSORBENT WITH HIGH CHLORIDE REMOVAL CAPACITY

(71) Applicant: SUD CHEMIE INDIA PVT LTD, Keria (IN)

(72) Inventors: Rekha Sree, Kerala (IN); Rajesh Gopinath, Kerala (IN); Sreekala Rugmini, Kerala (IN); Kishore Ravindran, Kerala (IN); Surya Prakash Babu, Haryana (IN); Iskander Altaf Lalljee, Haryana (IN); Arshia Altaf Lalljee, New Delhi (IN)

(21) Appl. No.: 18/274,251

(22) PCT Filed: Jan. 29, 2022
(86) PCT No.: PCT/IB2022/050790

§ 371 Date: Jul. 26, 2023

(30) Foreign Application Priority Data
Jan. 29, 2021 (IN) 202141003945

(51) Int. Cl. B01J 20/04; B01D 53/02; B01J 20/12; B01J 20/28; B01J 20/30

(52) U.S. Cl. CPC B01J 20/043; B01D 53/02; B01J 20/12; B01J 20/28004; B01J 20/28011; B01J 20/28019; B01J 20/2803; B01J 20/28059; B01J 20/28071; B01J 20/3007; B01J 20/3021; B01J 20/3078; B01D 2253/112; B01D 2253/304; B01D 2253/306; B01D 2253/311; B01D 2257/2045

(57) ABSTRACT

The present invention discloses an adsorbent composition for removing halogen-containing contaminants such as hydrogen chloride from gas streams and a process for its formation. The adsorbent composition comprises an active metal component and a carrier or binder. The active metal component is selected from the group consisting of sodium, potassium, magnesium, calcium and barium and the carrier/binder is selected from a group of clay materials like sepiolite, montmorillonite, kaolin or attapulgite.

### FIELD OF THE INVENTION

This invention relates to a solid adsorbent that completely removes inorganic chlorides particularly HCl from various hydrocarbon containing streams. The preferred hydrocarbon feed is a refinery stream. The adsorbent of this invention has a chloride adsorption capacity three times higher than that of presently known chloride adsorbents with reduced tendency to catalyze the formation of ‘Green Oil’. Removal of trace amount of chloride impurities from the hydrocarbon gas stream is very important in the preparation of various products as it serves as a poison for the catalyst located downstream. This invention further relates to a method of making such adsorbent and a method of removing HCl from fluid streams using such adsorbent.

### BACKGROUND OF THE INVENTION

Refineries are experiencing significant problems with regard to hydrocarbon contamination and this issue is becoming a day to day challenge considering the continuous industrial growth and environmental concerns. The solution could solve the concern for a safer and economic operation. The contaminants include acid gases such as HCl, HF, HBr, HI and mixtures thereof where HCl is a problem in particular. Chloride compounds have been recognized as serious poisons to many catalytic reactions. Further, chlorides in trace quantities significantly reduce the sulfur adsorption capacity of sulfur adsorbents also. Hence, chloride in the feed stock not only act as poison for the downstream catalysts of hydrogen and ammonia plants, but also act as poisons for the sulfur adsorbents. These contaminants result in the corrosion of processing equipments as well.

During the reforming process, along with hydrogen small amount of HCl is also carried away. Refiners typically remove the chloride compounds of interest by passing process streams through a fixed bed of adsorbents. The chlorides are generally present in the inorganic form, HCl. However, some refiners have reported organic chlorides, trace levels of C2 to C4 olefins as well. These chloride species can be typically in the range of 1-10 ppm. Inorganic chlorides due to their high corrosiveness, causes operating issues in the downstream equipment. Organic chlorides, though not significantly corrosive, decompose at low temperatures to generate HCl and the corresponding hydrocarbon.

Adsorbents based on activated alumina, promoted alumina, metal oxides and zeolites are the most common effective HCl scavenger.

US Patent 2002/0060308 relates to an absorbent comprising of zinc oxide, inert binder such as clay and porous refractory inorganic material like kieselguhr for effectively removing chlorides from a flow of hydrocarbon such as a catalytically reformed gasoline, The absorbent according to the invention has a high strength, and hardly decreases in the strength and powders due to moisture in crude petroleum. and can be used for a long time up to a near theoretical value of absorbing capacity.

U.S. Pat. No. 6,558,641 relates to a shaped adsorbent for use as chloride adsorbent comprising of sodium carbonate or bicarbonate, basic zinc carbonate or zinc oxide, alumina or hydrated alumina and binder comprising of calcium aluminate or clay such as attapulgite or sepiolite. The adsorbent mentioned in the prior arts contains zinc compounds as active material, which is an expensive material, compared to the sodium carbonates of the subject invention.

U.S. Pat. Nos. 5,316,998, 4,639,259, 5,505,926 and 4,762,537 describes the removal of HCl from the hydrocarbon feed using adsorbents based on activated alumina and activated alumina impregnated with an alkaline earth metal salt or zeolites.

U.S. Pat. No. 5,897,845 assigned to ICI, describes adsorbent granules comprising an intimate mixture of alumina trihydrate, sodium component selected from the group consisting of sodium carbonate, sodium bicarbonate and mixtures thereof. The said alumina trihydrate, sodium component and binder being present in such proportion that after ignition at 900° C. the sample has Na₂O content of at least 20% by weight calculated on an ignited base (900° C.). This material was referred for use at temperatures below 150° C.

Blachman disclosed in U.S. Pat. No. 6,200,544, an adsorbent with sufficient nodule crush strength for industrial applications that is effective in removing HCl from refinery and chemical plant fluid streams comprising activated alumina impregnated with alkali metal- or alkaline earth-oxide and promoted with phosphate or organic amine or a mixture thereof. The adsorbent of this invention exhibits superior capacity for HCl removal and reduced tendency to catalyze formation of Green Oil by its promotion with phosphate and/or organic amine.

U.S. Pat. No. 5,107,061 is directed towards the removal of organochlorides from hydrocarbon streams using highly crystalline molecular sieve material, such as zeolites in combination with alumina for the purpose of effecting a decomposition of the organochloride into a corresponding unsaturated hydrocarbon molecule and hydrocarbon chloride wherein the hydrocarbon chloride by the adsorbent.

US Patent No. 2018/0214844 A1 discloses a process where the particulate for removing halogenated compounds from a hydrocarbon-containing process stream comprises of a metal carbonate and/or a metal bicarbonate like calcium, potassium or sodium carbonates, compound of aluminum that is an alumina or a hydrated alumina (gibbsite) and binder (attapulgite clay). The adsorbent mentioned in the prior art contains compounds of alumina and is different to subject invention which consists of only sodium compounds and attapulgite.

There are numerous patents related towards the effective removal of inorganic chlorides using promoted activated alumina based on either alkali metal or zinc adsorbents. Attempts have been made to increase the chloride adsorption capacity by incorporating various other metals like zinc along with sodium carbonate and alumina tri-hydrate but product cost remains a bottleneck. Attempts were also made to increase the chloride adsorption capacity by increasing the content of promoters. However, the chloride pick up capacity is often limited to maximum 15-16 wt. %.

Therefore, there is a need to develop a low cost adsorbent based on a non-alumina and non-zinc composite for removing halogen-containing contaminants such as hydrogen chloride from gas streams with high pick up capacity.

### OBJECTIVE OF THE INVENTION

It is the objective of the present disclosure to address problems of the prior arts or to at least provide a useful alternative.

Another object of the present disclosure is to provide a non-alumina and non-zinc composite adsorbent for removing chloride compounds in hydrocarbon feed.

Another object of the present disclosure is not only to provide a cost effective adsorbent compared to the prior arts but also provide an adsorbent which picks up chloride with high capacities close to 40 wt. %.

### SUMMARY OF THE INVENTION

The preferred embodiments described herein provides an improved sorbent having increased HCl removal capacity particularly from the process fluid stream. This is achieved by developing an improved sorbent having chloride adsorption capacity three times that of the presently known chloride adsorbents.

One of the objects of the present invention is to provide an alumina free adsorbent for use as an HCl scavenger. Activated alumina adsorbents tend to promote the polymerization of olefins due to the inherent or resultant acidity of alumina. Since, olefins are commonly present in these applications, the resultant polymer causes a serious deposition known as “Green Oil” formation causing fouling concern to the downstream equipment. Typically, the adsorbent composition in the present disclosure comprises of sodium carbonate, sodium bicarbonate and low cost clay material such as attapulgite.

Another embodiment of the invention provides a process for removing HCl from fluid streams with the improved adsorbent having excellent structural integrity to withstand commonly used plant conditions for industrial applications.

### DETAILED DESCRIPTION OF THE INVENTION

The present invention relates to an adsorbent for removing halogenated compounds from a hydrocarbon containing process stream. Halogenated compounds may be organic halides such as alkyl or aryl halides or inorganic halides such as hydrogen chloride. The use of the adsorbent of this invention to remove HCl is particularly advantageous due to the improved adsorption capacity and cost competitiveness. It is well known that alkali promoted alumina acts as a scavenger for the removal of small quantities of HCl from gas streams. However, very little is known about the alumina free adsorbent for HCl removal. Newly developed adsorbent is having chloride adsorption capacity three times that of the presently known chloride adsorbents with minimal acid function to avoid unwanted side reactions.

An adsorbent, which could pick up chloride with close to 80% efficiency considering the amount of active sodium compounds loaded in the final product. Cost effective in terms of raw materials used for the preparation with chloride pick up capacity≥40 wt. %.

The present adsorbent comprises an intimate mixture of an active metal component and a carrier/binder that makes the adsorbent highly cost effective in terms of raw materials used for the preparation. The adsorbent composition wherein the said adsorbent is a non-alumina and non-zinc composite comprising of only metal carbonates, metal bicarbonates and clay.

The adsorbent of the present invention comprises a promoter that is an alkali metal in the form of carbonate or bicarbonate, but perhaps present in some other chemically bound hydroxycarbonates. including Sesquicarbonate (NaHCO₃·Na₂CO₃·2H₂O), Nahcolite (NaHCO₃), Wegscheiderite (Na₂CO₃·3NaHCO₃), Thermonatrite (Na₂CO₃⁻H₂O) and Eitelite (Na₂CO₃·MgCO₃).

The metal in the metal carbonate may be selected from a group consisting of sodium, potassium, magnesium, barium and calcium, preferably, sodium or magnesium in the powder form.

The amount of oxide in the total amount of carbonate and bicarbonate may be 10-60% by weight, preferably 30-55% and more preferably 45-50% by weight of the total mass of composition after ignition of the sample at 900° C.

Carrier/Binder used in the present invention comprises of a group of low cost clay materials for example sepiolite, montmorillonite, kaolin or attapulgite, preferably attapulgite with its primary clay mineral being palygorskite, a hydrous magnesium aluminium phyllosilicate. The amount of binder or carrier may be present as 30-60% by weight, preferably 35-55% and more preferably 45-50% by weight of the total mass of composition on dry basis. Furthermore, the binder itself is a very effective adsorbent material for the removal of the organic chloride contaminants present in the feed stream.

The process of preparation of the adsorbent comprises mixing of the components particularly alkali and/or alkaline earth metal carbonate and a binder by high speed ball milling for 60-120 minutes, more preferably for a time of 30-40 minutes to obtain a particle size of <20p. Further, process involves mixmulling with homogenization in solvents like acetone, propanol, alkali solution and water, more preferably with an alkali solution to form a wet solid. The alkali solution plays an important role in facilitating the reaction between the carbonate and the clay. The preferred alkali solution is selected from the group consisting of sodium acetate, sodium formate and sodium hydroxide.

The mixture was mixmulled until uniform to convert the mixture into a wet mass having good extrudability. The wet solid was then shaped in an extruder or nodulizer to form extrudates or spheres of 1.5-5 mm size. The shaped sorbents were dried in the range 50-100° C. in box furnace or belt calciner.

Adsorbent composition after drying consists of alkali metal carbonates preferably in the form of sodium carbonate monohydrate along with sodium bicarbonate and attapulgite.

The composite sorbent prepared according to the present invention have surface area ranging from 10 to 100 m²/g, pore volume ranging from 0.1 to 0.4 cc/g and average pore size ranging from 30 to 200 A°.

A further advantage of the adsorbent composition of the present disclosure compared to some other prior art sorbents is with regards to the mechanical stability both in fresh adsorbent before and after usage.

The mechanical or physical integrity of the adsorbent after usage was evaluated by the following method as described below.

The adsorbent of the present invention fully saturated with HCl having chloride pick up capacity≥40 wt. % was loaded in a fixed bed reactor and flooded with water and steam. The adsorbent after treatment with water and steam was found to be intact without any loss in mechanical or physical integrity and could be unloaded from the reactor easily. Accordingly, the said adsorbent composition is mechanically stable without any disintegration and powdering after treatment with water and steam.

The invention is useful in the treatment of a gas stream comprising a net hydrogen stream from a catalytic reforming process, where the hydrogen halide is hydrogen chloride.

In a typical process, HCl is removed by passing the HCl contaminated gas either in a down- or in an up-flow manner through the adsorbent kept as a fixed bed. Highest performance can be achieved with streams having about 1% by volume HCl. Larger quantities of HCl may cause saturation of the sorbent with early break-through. The adsorbent of the present disclosure was tested for HCl adsorption capacities by passing through N₂ containing 1% HCl feed by volume. The feed gas was passed over the sorbent at GHSV of 1800 h⁻¹ at temperatures 40° C., 60° C., 80° C. and pressure 6 kg. The gas was passed over the sorbent until a breakthrough in HCl occurred measured by Mitsubishi NSX analyzer. The experiment was terminated when 0.5 ppm by volume HCl is detected in the reactor outlet. The sorbent in the present invention is effective in removing HCl from fluid streams in the range less than 1% by volume to less than 0.5 ppm.

### EXPERIMENTAL DETAILS

Various aspects of the present invention will be further illustrated with reference to the following non-limiting examples.

### Example 1

This is a commercial sodium impregnated alumina adsorbent for comparison having 10-11% Na₂O. Hereafter referred as Sample ‘A’

### Example 2

This example illustrates the use of different precursors as the source of active ingredient for the preparation of the sorbent having 11% Na₂O by weight in the finished product on dry basis i.e. after calcination at 900° C. Four different sodium precursors (sodium carbonate, sodium bicarbonate, sodium formate and sodium acetate) were selected as the active ingredient. In addition, it contains ATH or gibbsite, binder and activated alumina. Active ingredient comprised of 11% Na₂O on dry basis.

The sorbent was prepared as follows: A quantity of the pulverized material produced by high speed ball milling for 30-40 minutes, more preferably for a time of 60-120 minutes to obtain a particle size of <20μ was weighed and transferred to a mix-muller. The mixture was mixmulled until uniform with dilute alkali solution to convert the mixture into a wet mass having good extrudability. This mass was then extruded to 3 mm plain extrudates, cured in atmosphere for about 24 h. The extrusions were then cut into short lengths and calcined at 150° C. for 3 h (Table 1). The extrudates were then tested for chloride adsorption capacity as described in EXAMPLE 6.

TABLE 1

| Sample | Na₂O | Chloride pick up |
|---|---|---|
| ID | Precursor | (Cl⁻), % |
| 1-1 | Na₂CO₃ | 9 |
| 1-2 | NaHCO₃ | 12 |
| 1-3 | NaCOOH | 6 |
| 1-4 | NaOOCH₃ | 7 |

### Example 3

This example illustrates the preparation of a sorbent of the present invention mentioned in Example 1. The adsorbent giving maximum chloride pick up from Example 1 was prepared by varying the composition of the active ingredient. Adsorbent comprised of 11%, 20%, 30%, 50% and 60% Na₂O as the active ingredient. In addition, it contains ATH or Gibbsite, binder and activated alumina. The process mentioned in Example 1 was adopted for preparation and evaluation.

TABLE 2

| Sample | Na₂O, | Average crushing | Bulk density, | Chloride |
|---|---|---|---|---|
| ID | % | Strength , Kg | Kg/l | pick up, % |
| 2-1 | 11 | 9.8 | 0.85 | 12 |
| 2-2 | 20 | 12.8 | 0.85 | 20 |
| 2-3 | 30 | 13.2 | 0.88 | 27 |
| 2-4 | 50 | 11.1 | 0.91 | 45 |
| 2-5 | 60 | 7.1 | 0.9 | 33 |

The chloride pick percentage in Table 2 indicates that 50% active component is optimum to get maximum chloride adsorption capacity (45 wt. %).

### Example 4

Calcination temperature was optimized to maximize the chloride adsorption capacity & improve the physical integrity of the product. Series of experiments were conducted which illustrates the effect of different calcination temperatures. The adsorbent formulation from Example 3 [Sample ID 2-4] was selected for studying the impact of final calcination temperature.

The said sorbent was calcined at temperatures varying from 100 to 540° C. for 2 h in box furnace. It is apparent from the results in Table 3 that calcination beyond 250° C. drastically lowered the physical strength/integrity of the said sorbent.

TABLE 3

| | | | | Average |
|---|---|---|---|---|
| | | | Average | Crushing |
| | Calcination | Chloride | crushing | strength |
| Sample | temperature, | pickup, | strength, | after 1 |
| ID | ° C. | % | fresh, kg | week, kg |
| 3-1 | 100 | 46 | 11.1 | 10.3 |
| 3-2 | 150 | 45 | 9.3 | 7.7 |
| 3-3 | 250 | 40 | 7.1 | 3.0 |
| 3-4 | 400 | 35 | 6.6 | 2.1 |
| 3-5 | 540 | 33 | 5.4 | 0.9 |

Reduction in physical strength is believed to be due to the formation of dawsonite-type hydroxyl carbonates. ATH or Al(OH)₃ transforms completely to boehmite beyond 250° C. calcination. dawsonite is expected to be formed from the interaction of boehmite with sodium carbonates and after exposure to atmospheric conditions. Beside sodium, ammonium, potassium and lithium are also known to form dawsonite upon reaction with boehmite and alumina. It is also attributed that decrease in adsorption capacity could be due to the formation of an inactive carbonate form upon calcination at high temperature.

### Example 5

It is known that alumina promoted adsorbents tend to promote green oil formation. Also, boehmite-carbonates interaction lead to the formation of dawsonite type hydroxyl carbonate that is responsible for physical integrity loss.

Procedure for the preparation of adsorbent without alumina is described where in Sodium bi carbonate, attapulgite and alkali are used as raw materials. Adsorbent comprising Sodium bi carbonate equivalent to 10%, 20%, 30%, 50% and 60% Na₂O by mass is prepared as described below.

Adsorbent comprising Sodium bicarbonate [1.2 kg] equivalent to 50% mass and Attapulgite [0.562 kg] were mixmulled until uniform with dilute alkali solution to convert the mixture into a wet mass having good extrudability. This mass was then extruded to 3 mm plain extrudates. The extrusions were then cut into short uniform lengths and dried between 50-100° C. in box furnace or a belt calciner.

The sample hereafter referred as ‘Sample B’.

Physico-chemical properties of the sample are given in the table below:

TABLE 4

| | |
|---|---|
| Average crushing strength, fresh, kg | 6.5 |
| Bulk density, kg/l | 0.72 |
| Surface area, m²/g | 35 |
| Mercury pore volume, ml/g | 0.30 |
| Crushing strength, spent [after HCl adsorption], kg | 6.7 |

### Example 6

Chloride Breakthrough Test of select adsorbent composition from examples 1, 3, 4 & 5

Selected samples were tested for chloride adsorption capacity in a fixed bed reactor with 26 mm ID and 500 mm length. 30 cc of the sized sample (850μ-1 mm) was tested for HCl adsorption capacities by passing though N₂ containing 1% HCl feed by volume. The feed gas was passed over the sorbent at GHSV of 1800 h⁻¹. The reactor was operated at temperatures 40° C., 60° C., 80° C. and pressure 6 kg. The gas was passed over the sorbent until a breakthrough in HCl occurred measured by Mitsubishi NSX analyzer. The experiment was terminated when 0.5 ppm by volume HCl is detected in the reactor outlet. Breakthrough time was recorded for calculating the chloride pick capacities. The bed was then purged with pure N₂ and the spent particulates distributed in 3 separate bed segments were subjected to chemical analysis by standard volumetric titration method to determine the chloride content.

Table 5 shows the Cl pick up values as determined by analysis of spent samples from breakthrough experiments.

TABLE 5

| | Cl⁻ content in the |
|---|---|
| Sample | spent sample |
| Sample A | 10.7 |
| Sample 2-4 | 45 |
| Sample 3-1 | 46.1 |
| Sample B | 47.5 |

### Example 7

Determination of Crushing Strength and Particle Size

Crushing strength was measured on a Zwick Roell machine. Extrudate is placed on top of bottom plunger so as to keep the curved portion of extrudate resting on the plunger. Machine will record the readings. Analysis is performed for minimum fifty extrudates and the average crush strength is determined in kilograms.

Particle size was determined by Malvern's Mastersizer 3000 using the technique of laser diffraction to measure the particle size.

### Example 8

This example demonstrates the determination of penetration depth of the adsorbents after breakthrough test.

The sorbents prepared in the above examples and evaluated according to Example 6 were subjected to penetration depth analysis. The chlorinated sample was treated with Universal Indicator at ambient temperature. Visual inspection of the adsorbents before and post HCl adsorption for coloration after treatment with Universal Indicator gives the qualitative indication of penetration depth. Adsorbents before HCl adsorption gave a blue to violet color with Universal Indicator while those after HCl adsorption or treatment gave a reddish coloration. Adsorbent prepared according to example 5 referred as Sample B gave reddish coloration on treatment with Universal Indicator which confirms that the entire adsorbent bed is saturated with HCl.

1. An adsorbent composition for removing halogen-containing contaminants such as hydrogen chloride from gas streams comprising;
an active metal component for adsorption and
a carrier or binder for impartinq mechanical stability.

2. The adsorbent composition of claim 1 wherein the active metal component in carbonates form is selected from the group consisting of sodium, potassium, magnesium, calcium and barium.

3. The adsorbent composition of claim 1 wherein the carrier/binder is selected from a group of clay materials like sepiolite, montmorillonite, kaolin or attapulgite.

4. The adsorbent composition of claim 1 wherein the carrier/binder is attapulgite with its primary clay mineral being palygorskite.

5. The adsorbent composition of claim 1 wherein the carrier or binder is present in the range of 30 to 50 wt. % of the total mass of composition.

6. The adsorbent composition as claimed in claim 1, wherein the active metal component comprises:
a) Sodium carbonate in the range of 30 to 50 wt. % of the total mass of composition on dry basis
b) Sodium bicarbonate in the range of 1 to 20 wt. % of the total mass of composition on dry basis

7. The adsorbent composition of claim 6 wherein sodium carbonate exists in the form of Sodium carbonate monohydrate.

8. A process for preparing a shaped adsorbent active for HCl removal, the process comprising the following steps:
a) Dry mixing of sodium bicarbonates, attapulgite with alkali solution,
b) Mixmulling the solution from step (a) with an alkali solution to form a wet solid,
c) Shaping the wet solid from step (b) in an extruder or nodulizer to form extrudates or spheres, and
d) Drying the shaped adsorbents from step (c) in box furnace or belt calciner.

9. The process of claim 8 wherein the mixing process of step (a) takes place for a duration of 60-120 minutes.

10. The process of claim 8 wherein the particle size obtained after step (a) is <20 μm.

11. The process of claim 8 wherein the alkali solution in step (b) is selected from the group consisting of sodium acetate, sodium formate and sodium hydroxide.

12. The process of claim 8 wherein the wet solid is shaped to extrudate and spheres of 1.5 mm to 5 mm diameter in step (c).

13. The process of claim 8 wherein the drying temperature of shaped adsorbent in step (d) is in the range of 50-100° C.

14. The process of claim 8 wherein the average crushing strength of the adsorbent is in the range of 5-8 kg.

15. The adsorbent composition of claim 1 is capable of picking 35-45 wt. % hydrogen chloride from a gas stream close to the theoretical adsorption evaluated with the following parameters:
a) temperatures in the range of 40° C.-80° C.
b) a pressure of 6 kg/cm²
c) a gas hourly space velocity (GHSV) in the range of 1800 h¹
d) hydrogen chloride breakthrough at 0.5 ppmv through the adsorbent bed.

16. The adsorbent composition resulting from the process of claim 8 is capable of picking 35-45 wt. % hydrogen chloride from a gas stream close to the theoretical adsorption capacity evaluated with the following parameters:
e) temperatures in the range of 40° C.-80° C.
f) a pressure of 6 kg/cm²
g) a gas hourly space velocity (GHSV) in the range of 1800 h⁻¹
h) hydrogen chloride breakthrough at 0.5 ppmv through the adsorbent bed.

17. The adsorbent composition of claim 1 is mechanically stable without any disintegration and powdering after treatment with water and steam.

18. The adsorbent composition resulting from the process of claim 8 is mechanically stable without any disintegration and powdering after treatment with water and steam.
